(19) United States
(12) Patent Application Publication
(10) Pub. No.: US 2018/0195760 A1
(43) Pub. Date: Jul. 12, 2018

(54) COMBUSTION APPARATUS AND METHOD OF MANUFACTURING THE SAME

(71) Applicant: NORITZ CORPORATION, Hyogo (JP)

(72) Inventor: Toshihito KOUDUKI, Himeji-shi (JP)

(73) Assignee: NORITZ CORPORATION, Hyogo (JP)

(21) Appl. No.: 15/849,727

(22) Filed: Dec. 21, 2017

(30) Foreign Application Priority Data
Jan. 6, 2017 (JP) 2017-001053

(51) Int. Cl. F24H 1/14; F23L 17/00; F24H 8/00; B23P 15/00

(52) U.S. Cl. CPC F24H 1/145; F23L 17/005; F24H 2210/00; B23P 15/00; F24H 8/006

(57) ABSTRACT

A housing includes a back plate portion, a pair of side plate portions which extend forward from both side ends of the back plate portion, and a front opening. A chamber is arranged inside the housing and includes a first attachment surface 31ba inclined with respect to the back plate portion in a plan view and an intake port which opens forward in the first attachment surface. A fan includes a second attachment surface provided with an emission port and is attached to the chamber in a state in which the second attachment surface is opposed to the first attachment surface to communicate the emission port with the intake port of the chamber.

### BACKGROUND OF THE INVENTION

### Field of the Invention

The present invention relates to a combustion apparatus and a method of manufacturing the same.

### Description of the Background Art

For example, Japanese Patent Laying-Open No. 2015-68555 has been known as a conventional combustion apparatus.

Japanese Patent Laying-Open No. 2015-68555 discloses a combustion apparatus of a normal combustion type in which a fan is provided below a burner case. In this combustion apparatus, a tip end portion of the fan on a side of an emission port is attached to a bottom portion of the burner case with a screw. The fan case is attached to the burner case by screwing the screw from both of a front side and a rear side of the fan case.

### SUMMARY OF THE INVENTION

Normally, in assembling a combustion apparatus, a burner case is assembled in a housing of a combustion apparatus and thereafter a fan case is attached to the burner case. In assembly of the combustion apparatus, according to the publication, the screw should be screwed from both of the front side and the rear side of the fan case. Therefore, an operation for screwing is required on both of the front side and the rear side of the housing of the combustion apparatus and an assembly operation is complicated.

Since an operation on both of the front side and the rear side of the housing of the combustion apparatus is required also in a maintenance work for replacement of a fan, the maintenance work is also complicated.

An orientation of the fan case placed in the housing may be changed in order to permit an operation to assemble the combustion apparatus on only one of the front side and the rear side of the combustion apparatus. In this case, however, the housing for accommodating the fan case may increase in size and the combustion apparatus may increase in size.

An object of the present invention is to provide a combustion apparatus of which assembly and maintenance are facilitated and of which increase in size can be suppressed and a method of manufacturing the same.

A combustion apparatus according to the present invention includes a housing, a chamber, and a fan. The housing includes a back plate portion, a pair of side plate portions which extend forward from both side ends of the back plate portion and a front opening. The chamber is arranged inside the housing and includes a first attachment surface inclined with respect to the back plate portion in a plan view and an intake port which opens forward in the first attachment surface. The fan includes a second attachment surface provided with an emission port and is attached to the chamber in a state in which the second attachment surface is opposed to the first attachment surface to communicate the emission port with the intake port of the chamber.

According to the combustion apparatus in the present invention, the chamber is attached to the housing by being inserted into the housing through the front opening of the housing. With the chamber being attached to the housing, the intake port of the chamber opens forward in the first attachment surface. Therefore, the emission port of the fan can communicate with the intake port of the chamber by inserting the fan through the front opening of the housing. Therefore, in assembling the combustion apparatus, the combustion apparatus can be assembled by inserting both of the chamber and the fan through the front opening of the housing. Since the necessity for an operation for assembly on a rear side of the housing is thus obviated, the assembly operation is facilitated.

In maintenance as well, maintenance can be done simply by performing works from the front of the housing. Therefore, a maintenance work is also facilitated.

The intake port of the chamber opens forward in the first attachment surface. Therefore, mixture gas from the fan can be fed to the chamber diagonally rearward from diagonal front. A long length of a path for the mixture gas can thus readily be secured also in a small-sized combustion apparatus and the gas is well mixed. Therefore, it is not necessary to increase a size of the housing for better mixing of the gas. Therefore, increase in size of the combustion apparatus can be suppressed.

A combustion apparatus of which assembly and maintenance are facilitated and of which increase in size can be suppressed can thus be obtained.

In the combustion apparatus, the chamber includes a first attachment portion including the first attachment surface and an engagement portion having an opposing portion which is opposed to the first attachment portion with a gap lying therebetween. The fan includes a second attachment portion including the second attachment surface and an insertion portion connected to the second attachment portion and inserted in between the first attachment portion and the opposing portion while the chamber and the fan are fixed to each other.

By thus inserting the insertion portion in between the first attachment portion and the engagement portion, the insertion portion can be engaged with both of the first attachment portion and the engagement portion. Thus, the fan can be held by the chamber as being caught thereby before the fan is fixed to the chamber. Therefore, drop of the fan from the chamber during an operation to fix the fan to the chamber can be suppressed. Therefore, an operation to fix the fan to the chamber is facilitated.

In the combustion apparatus, the first attachment portion includes an inclined surface which continues to the first attachment surface. A portion of joint between the first attachment surface and the inclined surface forms a projecting corner portion in the plan view. The insertion portion is opposed to the corner portion with a gap lying therebetween in the plan view.

With the inclined surface, an area where the first attachment surface and the second attachment surface are opposed to each other can be decreased. Therefore, a high surface pressure between the first attachment surface and the second attachment surface can be secured. Therefore, sealability between the first attachment surface and the second attachment surface is improved.

When the portion of joint between the first attachment surface and the inclined surface forms a projecting corner portion in the plan view, burr is likely in the corner portion. In the plan view, however, the insertion portion is opposed to the corner portion with a gap lying therebetween. Therefore, the burr does not impair sealability between the first attachment surface and the second attachment surface.

In the combustion apparatus, the chamber further includes a reinforcement portion which connects the opposing portion and the first attachment portion to each other at a root of the engagement portion.

The reinforcement portion reinforces the engagement portion. Therefore, even when a weight of the fan is applied to the engagement portion due to engagement of the insertion portion with the engagement portion, break or bending of the engagement portion can be suppressed.

In the combustion apparatus, the second attachment portion includes a first side end portion located laterally to the emission port and a second side end portion while the emission port lies therebetween. The first side end portion is located closer to a position of a center of gravity of the fan than the second side end portion in the plan view. The insertion portion is provided in the first side end portion.

Since the insertion portion is provided in the first side end portion close to the position of the center of gravity, the fan is well balanced when the insertion portion is engaged with the engagement portion. An operation to attach the fan to the chamber is thus further facilitated.

The combustion apparatus further includes a fixing member which fixes the chamber and the fan to each other while the first attachment surface and the second attachment surface are opposed to each other.

The intake port of the chamber opens forward in the first attachment surface. Therefore, the fixing member inserted into the housing through the front opening of the housing can fix the chamber and the fan to each other. An operation to fix the chamber and the fan to each other with the fixing member can thus also be performed from the front of the housing and attachment and maintenance are facilitated.

In the combustion apparatus, the fixing member includes at least a first screw member and a second screw member. The chamber includes a first screw hole in which the first screw member is inserted and a second screw hole in which the second screw member is inserted. Both of the first screw hole and the second screw hole are arranged at positions higher than the intake port and the first screw hole is arranged at a position higher than the second screw hole with respect to the intake port.

The first screw hole is arranged at a high position. Therefore, even when a motor or the like is attached above the fan, the fixing member can be attached while avoiding the motor. The second screw hole is arranged at a position lower than the first screw hole, that is, a position close to the intake port. Therefore, the first attachment surface provided with the intake port and the second attachment surface provided with the emission port can more reliably be sealed.

A method of manufacturing a combustion apparatus according to the present invention includes steps below.

A housing including a back plate portion, a pair of side plate portions which extend forward from both side ends of the back plate portion and a front opening is prepared. A chamber including a first attachment surface provided with an intake port is inserted through the opening into the inside of the housing and attached to the housing such that the first attachment surface is inclined with respect to the back plate portion in a plan view and the intake port opens forward in the first attachment surface. A fan including a second attachment surface provided with an emission port is inserted through the opening into the inside of the housing and fixed to the chamber with the second attachment surface being opposed to the first attachment surface for communication of the emission port with the intake port of the chamber.

According to the method of manufacturing a combustion apparatus of the present invention, the chamber is attached to the housing by being inserted into the housing through the front opening of the housing. With the chamber being attached to the housing, the intake port of the chamber opens forward in the first attachment surface. Therefore, the emission port of the fan can communicate with the intake port of the chamber by inserting the fan through the front opening of the housing. Therefore, in assembling the combustion apparatus, the combustion apparatus can be assembled by inserting both of the chamber and the fan through the front opening of the housing. Since the necessity for an operation for assembly on the rear side of the housing is thus obviated, the assembly operation is facilitated.

In maintenance as well, maintenance can be done simply by performing works from the front of the housing. Therefore, a maintenance work is also facilitated.

The intake port of the chamber opens forward in the first attachment surface. Therefore, mixture gas from the fan can be fed to the chamber diagonally rearward from diagonal front. A long length of a path for the mixture gas can thus readily be secured also in a small-sized combustion apparatus and the gas is well mixed. Therefore, it is not necessary to increase a size of the housing for better mixing of the gas. Therefore, increase in size of the combustion apparatus can be suppressed.

A combustion apparatus of which assembly and maintenance are facilitated and of which increase in size can be suppressed can thus be obtained.

In the method of manufacturing a combustion apparatus, the chamber is prepared to include a first attachment portion including the first attachment surface and an engagement portion having an opposing portion which is opposed to the first attachment portion with a gap lying therebetween. The fan is prepared to include a second attachment portion including the second attachment surface and an insertion portion provided in the second attachment portion. The insertion portion of the fan is inserted in between the first attachment portion and the opposing portion of the chamber after the fan is inserted into the inside of the housing through the front opening and before the fan is fixed to the chamber.

As the insertion portion is thus inserted in between the first attachment portion and the opposing portion, the insertion portion can be engaged with both of the first attachment portion and the engagement portion. Thus, the fan can be held by the chamber as being caught thereby before the fan is fixed to the chamber. Therefore, drop of the fan from the chamber during an operation to fix the fan to the chamber can be suppressed. Therefore, an operation to fix the fan to the chamber is facilitated.

In the method of manufacturing a combustion apparatus, after the insertion portion is inserted in between the first attachment portion and the engagement portion, a fixing member inserted into the inside of the housing through the front opening fixes the chamber and the fan to each other.

The intake port of the chamber opens diagonally forward in the first attachment surface. Therefore, the fixing member inserted into the housing through the front opening of the housing can fix the chamber and the fan to each other. An operation to fix the chamber and the fan to each other with the fixing member can also be performed from the front of the housing and attachment and maintenance are facilitated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a construction of a combustion apparatus in one embodiment of the present invention.

FIG. 2 is a perspective view schematically showing a partial construction in the combustion apparatus in one embodiment of the present invention.

FIG. 3 is a perspective view schematically showing a construction of a chamber included in the combustion apparatus in one embodiment of the present invention.

FIG. 4 is a perspective view schematically showing a construction of a fan included in the combustion apparatus in one embodiment of the present invention.

FIG. 5 is a perspective view showing a state that the chamber shown in FIG. 3 and the fan shown in FIG. 4 are assembled.

FIG. 6 is a partially exploded perspective view showing the state that the chamber shown in FIG. 3 and the fan shown in FIG. 4 are assembled.

FIG. 7 is a partially exploded perspective view showing a region VII in FIG. 6 as being enlarged.

FIG. 8 is a schematic cross-sectional view along the line VIII-VIII in FIG. 7.

FIG. 9 is a plan view showing a state of arrangement of the chamber and the fan in a housing.

FIG. 10 is a plan view showing a first step of a method of manufacturing a combustion apparatus in one embodiment of the present invention.

FIG. 11 is a plan view showing a second step of the method of manufacturing a combustion apparatus in one embodiment of the present invention.

FIG. 12 is a diagram showing a state that the fan is caught by the chamber before the fan is fixed to the chamber.

FIG. 13 is a diagram showing a state that the fan is fixed to the chamber.

### DESCRIPTION OF THE PREFERRED EMBODIMENTS

An embodiment of the present invention will be described below with reference to the drawings.

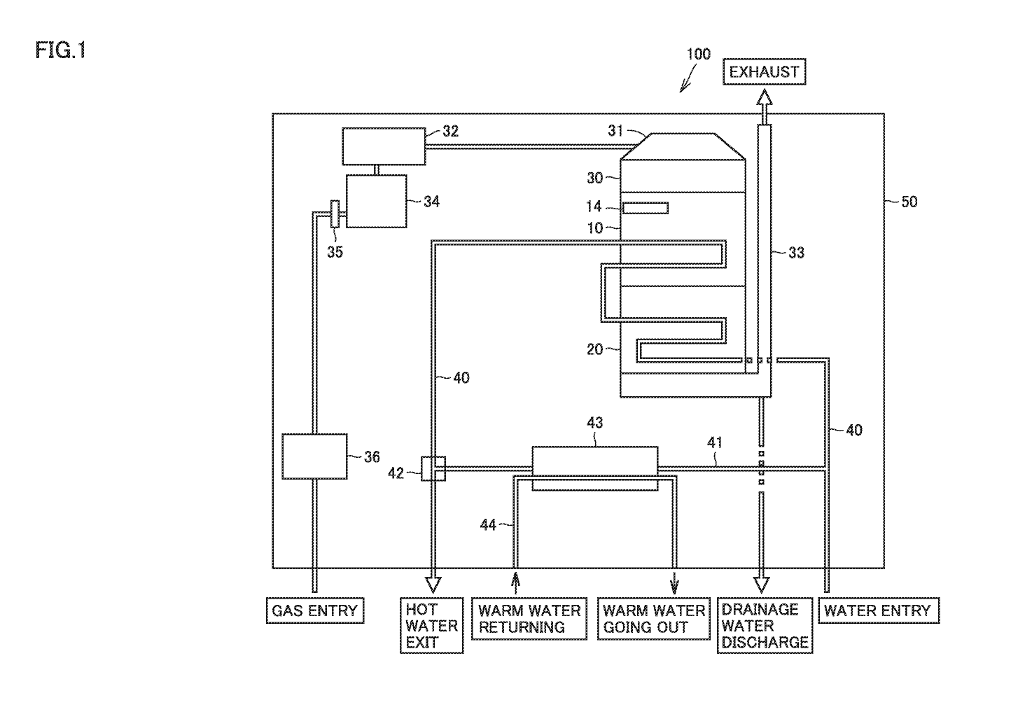

A construction of a combustion apparatus in one embodiment of the present invention will initially be described with reference to FIG. 1. A plan view in the description below means a point of view in a direction orthogonal to an upper surface of a flat plate portion 31a of a chamber 31 or a point of view in a direction orthogonal to an upper surface of a top plate portion 50d of a housing 50.

As shown in FIG. 1, a combustion apparatus 100 in the present embodiment mainly includes a sensible heat recovery heat exchanger (primary heat exchanger) 10, a latent heat recovery heat exchanger (secondary heat exchanger) 20, a burner 30, a chamber 31, a fan (fan assembly) 32, a duct 33, a venturi 34, an orifice 35, a gas valve 36, a pipe 40, a bypass pipe 41, a three-way valve 42, a liquid to liquid heat exchanger 43, a hydronic pipe 44, and a housing 50. All of components except for housing 50 among the components above are arranged in housing 50.

Gas valve 36, orifice 35, and venturi 34 are connected to the pipe in this order. Fuel gas can be supplied from the outside of housing 50 to this pipe. The fuel gas supplied to this pipe flows to venturi 34 through gas valve 36 and orifice 35.

Gas valve 36 is configured to control a flow rate of the fuel gas. Venturi 34 is configured to increase a flow velocity of mixture gas by reducing the flow of the mixture gas of the fuel gas and air. Venturi 34 is constructed to take in air from the outside of housing 50. Venturi 34 is constructed to mix air taken in from the outside of housing 50 and the fuel gas supplied through the pipe.

Venturi 34 is connected to fan 32 through the pipe. The mixture gas mixed in venturi 34 is sent through this pipe to fan 32. Fan 32 is configured to supply the mixture gas to burner 30. Fan 32 mainly includes a fan case, an impeller arranged in the fan case, and a drive source (such as a motor) for rotating the impeller.

Fan 32 is connected to chamber 31 and chamber 31 is connected to burner 30. The mixture gas sent from fan 32 is sent through chamber 31 to burner 30.

Burner 30 is configured to generate combustion gas as heating gas by burning the mixture gas. Burner 30 is an inverse combustion type apparatus which supplies combustion gas downward. The mixture gas issued from burner 30 is ignited by an ignition plug 14 and becomes the combustion gas. Ignition plug 14 is provided, for example, in sensible heat recovery heat exchanger 10.

Burner 30, sensible heat recovery heat exchanger 10, and latent heat recovery heat exchanger 20 are connected such that the combustion gas sequentially passes through sensible heat recovery heat exchanger 10 and latent heat recovery heat exchanger 20. Specifically, sensible heat recovery heat exchanger 10 is attached under burner 30 and latent heat recovery heat exchanger 20 is attached under sensible heat recovery heat exchanger 10.

Duct 33 is connected to latent heat recovery heat exchanger 20 and duct 33 extends to the outside of housing 50. The combustion gas which has passed through latent heat recovery heat exchanger 20 is thus emitted to the outside of housing 50 through duct 33.

Each of sensible heat recovery heat exchanger 10 and latent heat recovery heat exchanger 20 is configured to heat water and/or hot water by exchanging heat between the combustion gas supplied from burner 30 and water and/or hot water.

Sensible heat recovery heat exchanger 10 is configured to recover sensible heat of the combustion gas generated by burner 30. Latent heat recovery heat exchanger 20 is configured to recover latent heat of the combustion gas. For example, a plate type heat exchanger is employed as latent heat recovery heat exchanger 20.

When a temperature of incoming water and/or hot water is low in sensible heat recovery heat exchanger 10 or when an amount of heating by burner 30 is small, water vapor in the combustion gas is condensed in sensible heat recovery heat exchanger 10 and condensed water (drainage water) is generated. Drainage water is generated also in latent heat recovery heat exchanger 20. Drainage water is drained to the outside of housing 50 through a part of duct 33.

A heat transfer tube of sensible heat recovery heat exchanger 10 and a heat transfer portion of latent heat recovery heat exchanger 20 are connected to each other through pipe 40. A part of pipe 40 on a water entry side relative to latent heat recovery heat exchanger 20 and a part of pipe 40 on a hot water exit side relative to sensible heat recovery heat exchanger 10 are bypassed by bypass pipe 41.

The part of pipe 40 on the hot water exit side relative to sensible heat recovery heat exchanger 10 and bypass pipe 41 are connected to each other by three-way valve 42. Three-way valve 42 is constructed to be able to switch between a flow path from sensible heat recovery heat exchanger 10 to a hot water outlet of pipe 40 and a flow path from sensible heat recovery heat exchanger 10 to bypass pipe 41.

Liquid to liquid heat exchanger 43 is connected to bypass pipe 41. Hydronic pipe 44 connected to a hydronic terminal is inserted in liquid to liquid heat exchanger 43. Liquid to liquid heat exchanger 43 is constructed such that warm water warmed as a result of passage through sensible heat recovery heat exchanger 10 and latent heat recovery heat exchanger 20 flows in liquid to liquid heat exchanger 43. As warm water which flows in liquid to liquid heat exchanger 43 flows outside hydronic pipe 44, heat can be exchanged between warm water which flows in liquid to liquid heat exchanger 43 and warm water which flows in hydronic pipe 44.

Water supplied to combustion apparatus 100 becomes hot as a result of heat exchange with the combustion gas in sensible heat recovery heat exchanger 10 and latent heat recovery heat exchanger 20. Hot water can thus be supplied by combustion

Warm water which returns from the hydronic terminal passes through hydronic pipe 44 to be warmed as a result of heat exchange with warm water warmed by sensible heat recovery heat exchanger 10 and latent heat recovery heat exchanger 20 in liquid to liquid heat exchanger 43 and thereafter it is supplied again to the hydronic terminal. Warm water can thus be supplied to the hydronic terminal by combustion apparatus 100.

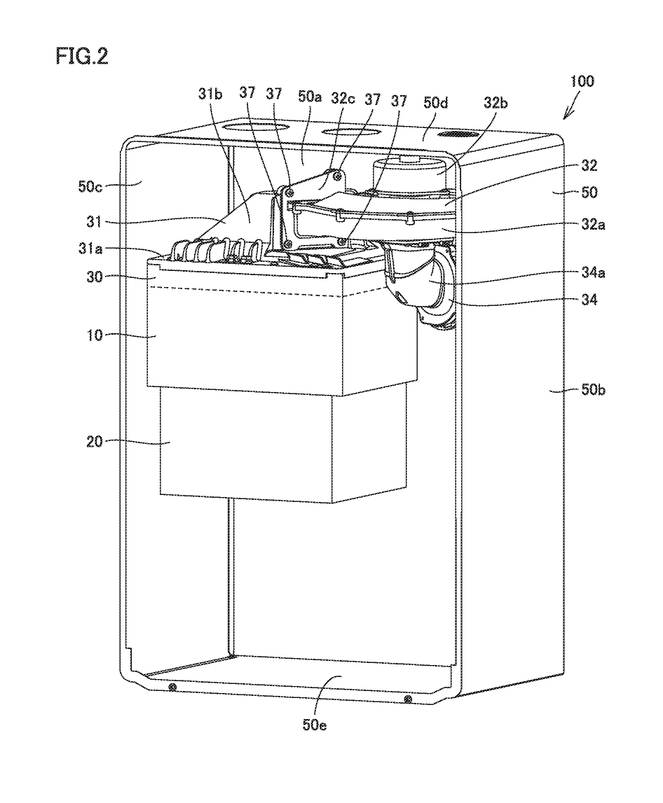

A construction of housing 50, chamber 31, and fan 32 included in combustion apparatus 100 will now be described with reference to FIGS. 2 to 4.

As shown in FIG. 2, housing 50 includes a back plate portion 50a, a pair of side plate portions 50b and 50c, a top plate portion 50d, and a bottom plate portion 50e. The pair of side plate portions 50b and 50c extend forward from both side ends of back plate portion 50a. Top plate portion 50d extends forward from an upper end of back plate portion 50a. Bottom plate portion 50e extends forward from a lower end of back plate portion 50a.

The pair of side plate portions 50b and 50c are connected to top plate portion 50d and bottom plate portion 50e to form a frame. A front opening is thus provided in housing 50. The front opening is closed by a not-shown front lid member after each component is accommodated as being assembled in the inside of housing 50.

As described above, sensible heat recovery heat exchanger 10, latent heat recovery heat exchanger 20, burner 30, chamber 31, fan 32, and venturi 34 are arranged inside housing 50. Chamber 31 is arranged, for example, on burner 30. Burner 30 is arranged, for example, on sensible heat recovery heat exchanger 10 and sensible heat recovery heat exchanger 10 is arranged, for example, on latent heat recovery heat exchanger 20.

Fan 32 is arranged, for example, laterally to chamber 31. Venturi 34 is arranged, for example, under fan 32. Fan 32 and venturi 34 are connected to each other through an elbow pipe 34a.

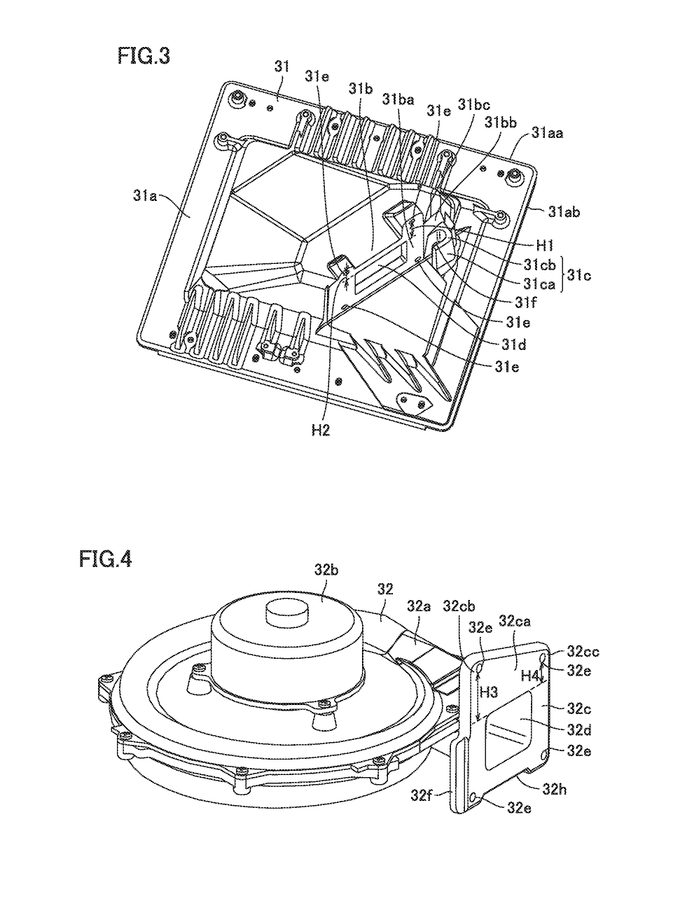

As shown in FIG. 3, chamber 31 includes a flat plate portion 31a and a first attachment portion 31b. An outer periphery of flat plate portion 31a in the plan view is substantially rectangular. First attachment portion 31b is located substantially in a central portion of flat plate portion 31a and projects upward from flat plate portion 31a. Flat plate portion 31a surrounds first attachment portion 31b in the plan view.

First attachment portion 31b includes a first attachment surface 31ba. First attachment surface 31ba is erected substantially perpendicularly to an upper surface of flat plate portion 31a. First attachment surface 31ba is inclined with respect to both of one side 31aa defining the rectangular shape of flat plate portion 31a and the other side 31ab intersecting with one side 31aa in the plan view.

An intake port 31d is provided in first attachment surface 31ba. Intake port 31d is an opening for supplying mixture gas supplied from fan 32 toward burner 30. Intake port 31d is substantially rectangular in first attachment surface 31ba.

A plurality of (for example, four) screw holes 31e (fixing member attachment portions) are provided in first attachment surface 31ba. Each of four screw holes 31e has a female screw portion. Four screw holes 31e are arranged in the vicinity of four respective corner portions of rectangular intake port 31d.

Two screw holes 31e of four screw holes 31e are located under intake port 31d (on a side of flat plate portion 31a). Other two screw holes 31e of four screw holes 31e are located above intake port 31d (opposite to flat plate portion 31a). One screw hole 31e (a first screw hole) of two screw holes 31e located above intake port 31d is arranged at a position higher than the other screw hole 31e (a second screw hole) with respect to intake port 31d. Specifically, a height H1 of one screw hole 31e from an upper end of intake port 31d is greater than a height H2 of the other screw hole 31e from the upper end of intake port 31d.

First attachment portion 31b includes an inclined surface 31bb. Inclined surface 31bb continues to one end portion of first attachment surface 31ba. A portion of joint 31bc between inclined surface 31bb and first attachment surface 31ba forms a projecting corner portion in the plan view. An angle formed between inclined surface 31bb and first attachment surface 31ba in the plan view (that is, an angle of corner portion 31bc) is smaller than 180°.

Chamber 31 includes an engagement portion 31c. Engagement portion 31c includes an opposing portion 31ca and a connection portion 31cb. Opposing portion 31ca is opposed to first attachment portion 31b with a gap lying therebetween. Opposing portion 31ca is opposed to inclined surface 31bb with a gap lying therebetween. Connection portion 31cb connects opposing portion 31ca and inclined surface 31bb to each other. Opposing portion 31ca and connection portion 31cb are connected to each other to form substantially an L shape in the plan view.

A reinforcement portion 31f is provided at a root portion of engagement portion 31c. Reinforcement portion 31f projects upward from a surface where engagement portion 31c is provided. Reinforcement portion 31f connects first attachment portion 31b and opposing portion 31ca to each other.

As shown in FIG. 4, fan 32 includes a fan case 32a, a motor 32b, and an impeller (not shown). The impeller is rotatably arranged in the inside of fan case 32a. Motor 32b is attached to an upper portion of fan case 32a. Motor 32b provides driving force for rotation to the impeller in fan case 32a.

Fan case 32a includes a second attachment portion 32c. Second attachment portion 32c includes a second attachment surface 32c a. An emission port 32d is provided in second attachment surface 32ca. Emission port 32d communicates with an internal space in fan case 32a where the impeller is arranged.

Emission port 32d is an opening for emission of mixture gas mixed in venturi 34 from fan 32 toward chamber 31 owing to rotation of the impeller. Emission port 32d is substantially rectangular in second attachment surface 32ca.

A plurality of (for example, four) through holes 32e (fixing member insertion portions) are provided in second attachment surface 32ca. Four through holes 32e are arranged in the vicinity of four respective corner portions of rectangular emission port 32d.

Two through holes 32e of four through holes 32e are located under emission port 32d. Other two through holes 32e of four through holes 32e are located above emission port 32d.

One through hole 32e (a first through hole) of two through holes 32e located above emission port 32d is arranged at a position higher than the other through hole 32e (a second through hole) with respect to emission port 32d. Specifically, a height H3 of one through hole 32e from an upper end of emission port 32d is greater than a height H4 of the other through hole 32e from the upper end of emission port 32d.

One through hole 32e is arranged at a position higher than a highest portion of the upper surface of fan case 32a. The other through hole 32e is arranged at a position lower than the highest portion of the upper surface of fan case 32a.

Fan case 32a includes an insertion portion 32f Insertion portion 32f is connected to second attachment portion 32c and projects laterally from second attachment portion 32c. Second attachment portion 32c is arranged at a position which retracts toward motor 32b relative to second attachment surface 32ca of second attachment portion 32c.

A cut portion 32h is provided in a central portion of a lower end of second attachment portion 32c. Opposing end portions of the lower end of second attachment portion 32c where no cut portion 32h is provided extend downward as being lower than the central portion where cut portion 32h is provided.

Second attachment portion 32c includes a first side end portion 32cb located laterally to emission port 32d and a second side end portion 32cc with emission port 32d lying therebetween.

A state that chamber 31 and fan 32 are fixed will now be described with reference to FIGS. 5 to 9.

As shown in FIG. 5, chamber 31 and fan 32 are fixed by a fixing member 37 with first attachment surface 31ba (FIG. 3) of chamber 31 and second attachment surface 32ca (FIG. 4) of fan 32 being opposed to each other. For example, a screw is employed for fixing member 37, however, a pin may be employed.

Fixing member 37 passes through through hole 32e in fan 32 and is screwed into the female screw portion of screw hole 31e of chamber 31. Fan 32 is thus fixed to chamber 31.

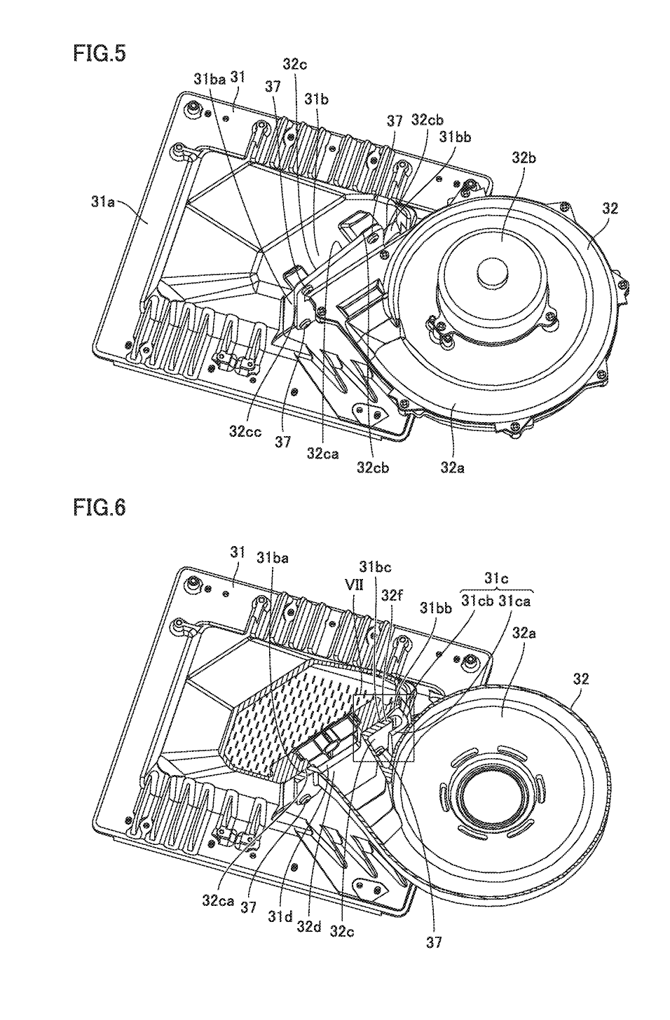

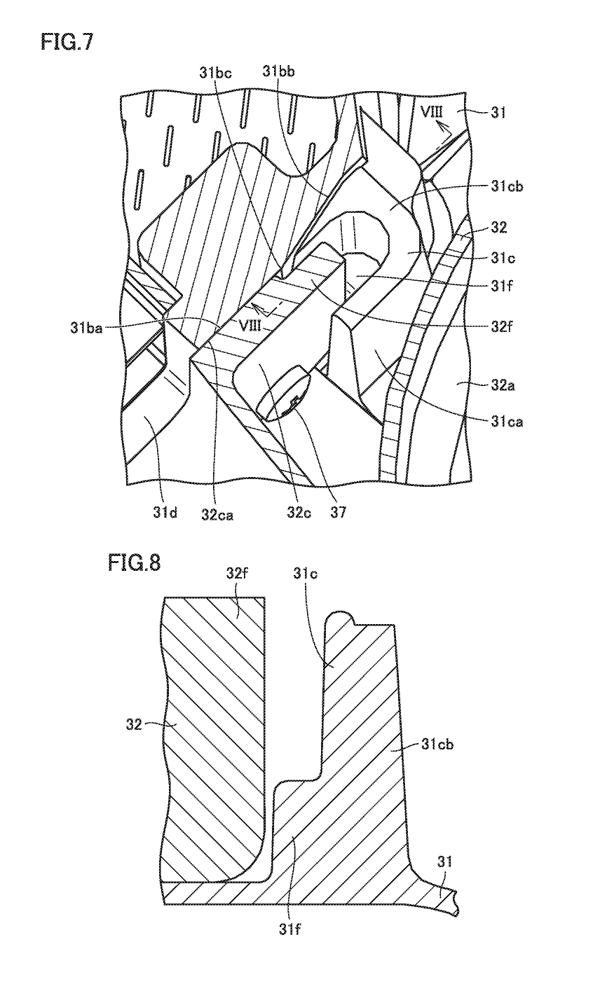

As shown in FIG. 6, with fan 32 being fixed to chamber 31, emission port 32d (FIG. 4) of fan 32 communicates with intake port 31d (FIG. 3) of chamber 31. In this fixed state, a sealing member (not shown) is arranged between first attachment surface 31ba and second attachment surface 32ca of fan 32. This sealing member is arranged to surround emission port 32d and intake port 31d. The sealing member prevents the mixture gas from leaking from emission port 32d and intake port 31d.

As shown in FIGS. 6 and 7, in the fixed state, insertion portion 32f of fan 32 is inserted in a gap between opposing portion 31ca of engagement portion 31c and first attachment portion 31b.

In this fixed state, insertion portion 32f is located away from first attachment portion 31b relative to second attachment surface 32ca. Insertion portion 32f is thus opposed to the corner portion formed in portion of joint 31bc (FIG. 7) between first attachment surface 31ba of chamber 31 and inclined surface 31bb, with a gap lying therebetween.

As shown in FIGS. 7 and 8, in the fixed state, insertion portion 32f is arranged to avoid reinforcement portion 31f of chamber 31. Specifically, insertion portion 32f does not extend as far as reinforcement portion 31f and there is a gap between the insertion portion and reinforcement portion 31f. Insertion portion 32f may ride over an upper surface of reinforcement portion 31f in the fixed state.

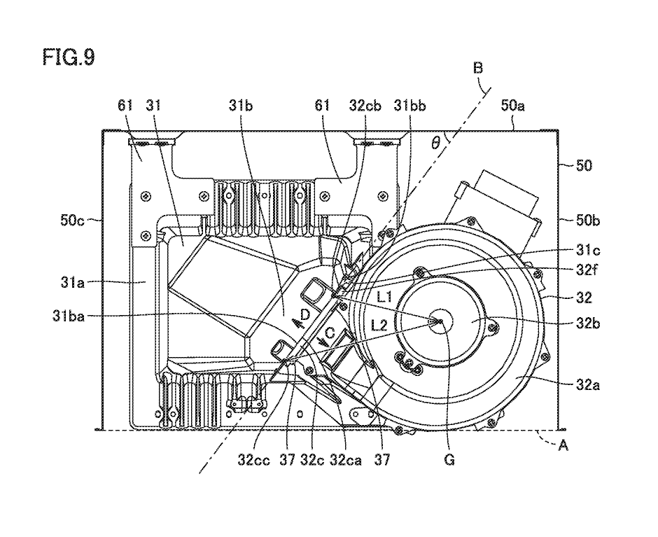

As shown in FIG. 9, chamber 31 and fan 32 are arranged inside housing 50. Inside of housing 50 refers to a space surrounded by back plate portion 50a, the pair of side plate portions 50b and 50c, top plate portion 50d, bottom plate portion 50e, and the front lid member (not shown) described above of housing 50. FIG. 9 shows a dashed line A instead of the front lid member for the sake of brevity.

With chamber 31 and fan 32 being arranged inside housing 50, first attachment surface 31ba of chamber 31 is inclined with respect to back plate portion 50a in the plan view. Specifically, in the plan view, a virtual extension B of first attachment surface 31ba intersects with back plate portion 50a at an angle θ which is greater than 0° and smaller than 90°. More preferably, such an angle that a line which is an extension of a central axis of through hole 32e on a side of first side end portion 32cb (a chain dotted line close to first side end portion 32cb in FIG. 11) does not intersect with a front end portion of side plate portion 50b of housing 50 in the plan view is desirable.

Intake port 31d provided in first attachment surface 31ba thus opens diagonally forward (in a direction shown with an arrow C in the figure) in first attachment surface 31ba in the plan view. Emission port 32d provided in second attachment surface 32ca opens diagonally rearward (a direction shown with an arrow D in the figure) in second attachment surface 32ca in the plan view.

As described above, second attachment portion 32c includes first side end portion 32cb located laterally to emission port 32d and second side end portion 32cc with emission port 32d lying therebetween. In the plan view, first side end portion 32cb is located closer to a position of a center of gravity G of fan 32 than second side end portion 32cc. Insertion portion 32f is provided in first side end portion 32cb.

For the sake of brevity of illustration, FIG. 9 shows the position of center of gravity G of fan 32 at the center of rotation of motor 32b, however, the position of center of gravity G is not necessarily located at the center of rotation of motor 32b. Whichever portion of fan 32 the position of center of gravity G of fan 32 may be located in the plan view, insertion portion 32f is preferably arranged in a side end portion of two side end portions 32cb and 32c c of second attachment portion 32c, which is closer to the position of center of gravity G.

In the plan view, engagement portion 31c is preferably arranged at a position closer to back plate portion 50a than intake port 31d. A gap between opposing portion 31ca of engagement portion 31c and first attachment portion 31b preferably opens diagonally forward in a direction of extension of first attachment surface 31ba in the plan view.

One screw hole 31e arranged at the higher position with respect to intake port 31d, of two screw holes 31e arranged above intake port 31d described with reference to FIG. 3, is preferably arranged at a position closer to back plate portion 50a than the other screw hole 31e arranged at the position lower with respect to intake port 31d.

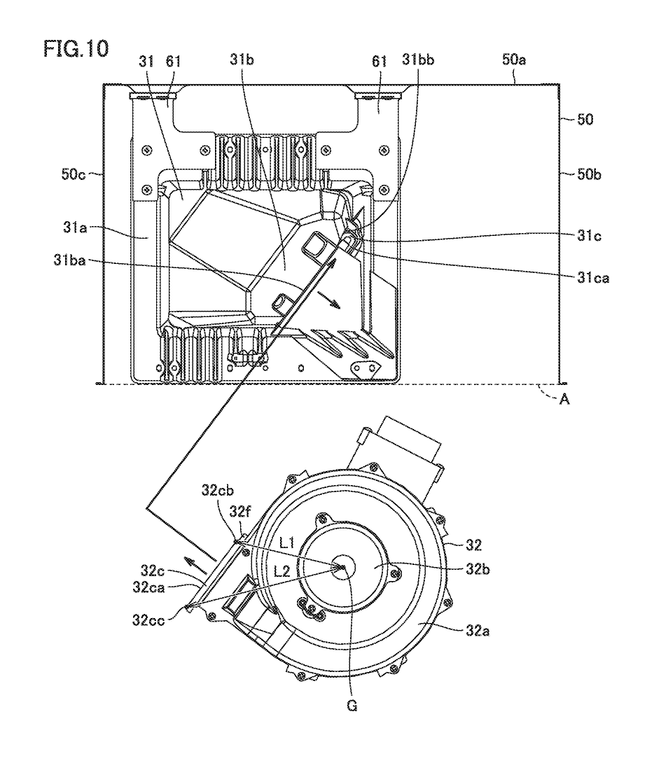

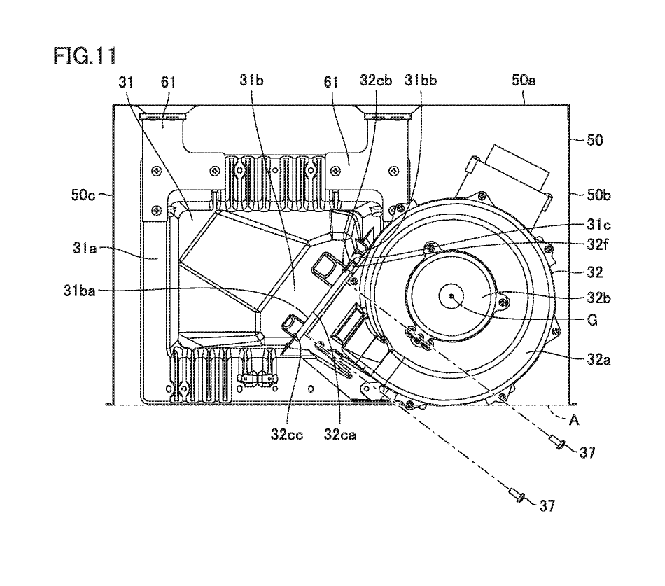

A method of manufacturing a combustion apparatus will now be described with reference to FIGS. 10 to 13.

As shown in FIG. 10, housing 50 as described above is initially prepared. Specifically, housing 50 including back plate portion 50a, the pair of side plate portions 50b and 50c, top plate portion 50d, and bottom plate portion 50e and including the front opening is prepared.

The pair of side plate portions 50b and 50c extend forward from both side ends of back plate portion 50a. Top plate portion 50d extends forward from the upper end of back plate portion 50a. Bottom plate portion 50e extends forward from the lower end of back plate portion 50a. The pair of side plate portions 50b and 50c are connected to top plate portion 50d and bottom plate portion 50e to form a frame. The front opening is thus provided in housing 50.

Chamber 31 as described above is prepared. Specifically, chamber 31 including flat plate portion 31a, first attachment portion 31b, and engagement portion 31c is prepared. First attachment portion 31b includes first attachment surface 31ba provided with intake port 31d. Engagement portion 31c is arranged laterally to first attachment surface 31ba. Engagement portion 31c includes opposing portion 31ca opposed to first attachment portion 31b.

Fan 32 as described above is prepared. Specifically, fan 32 including fan case 32a, motor 32b, and the impeller is prepared. Fan case 32a includes second attachment portion 32c. Second attachment portion 32c includes second attachment surface 32c a provided with emission port 32d. Insertion portion 32f is provided in second attachment portion 32c as projecting from second attachment portion 32c. Venturi 34 is attached to fan 32 with elbow pipe 34a being interposed.

Then, chamber 31 connected to burner 30 and sensible heat recovery heat exchanger 10 is inserted into the inside of housing 50 through the front opening of housing 50. Thereafter, chamber 31 is attached and fixed to housing 50. Chamber 31 is fixed to housing 50 such that first attachment surface 31ba of chamber 31 is inclined with respect to back plate portion 50a and intake port 31d opens diagonally forward in first attachment surface 31ba in the plan view.

Chamber 31 is attached and fixed to housing 50, for example, with an attachment member 61 being interposed.

Then, fan 32 to which venturi 34 is attached is inserted into the inside of housing 50 through the front opening of housing 50. Thereafter, fan 32 is arranged with respect to chamber 31 such that second attachment surface 32ca of fan 32 is opposed to first attachment surface 31ba of chamber 31. Insertion portion 32f of fan 32 is inserted in a gap between engagement portion 31c and first attachment portion 31b of chamber 31.

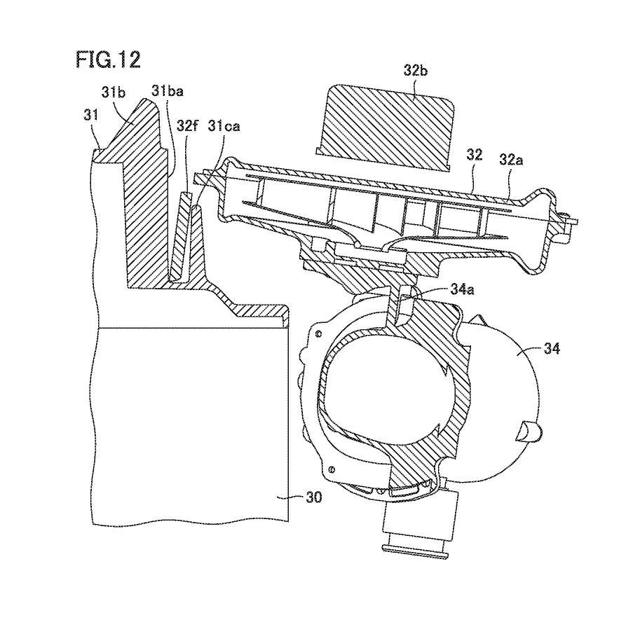

As shown in FIG. 12, with insertion portion 32f being inserted in between engagement portion 31c and first attachment portion 31b, fan 32 and venturi 34 tend to drop due to a self weight of fan 32 and venturi 34. As insertion portion 32f is inclined with respect to chamber 31, it is engaged with (abuts on) each of engagement portion 31c and first attachment portion 31b. Fan 32 is thus caught by chamber 31 so that fan 32 and venturi 34 are prevented from dropping.

As shown in FIG. 11, thereafter, fan 32 is attached and fixed to chamber 31. Fan 32 is fixed to chamber 31 with second attachment surface 32ca being opposed to first attachment surface 31ba for communication of emission port 32d of fan 32 with intake port 31d of chamber 31.

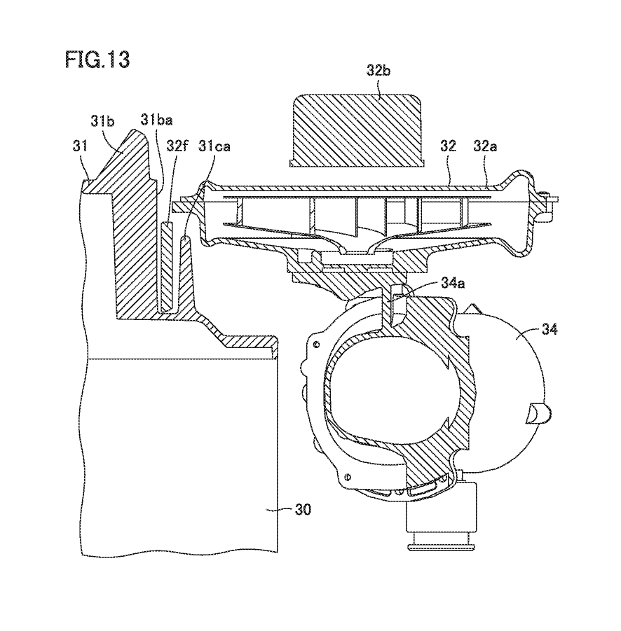

Fixing is achieved by fixing member 37 (for example, a screw member) inserted into the inside of housing 50 through the front opening of housing 50. Specifically, fixing member 37 passes through through hole 32e (FIG. 4) of fan 32 and is fixed (for example, screwed) to screw hole 31e (FIG. 3) of chamber 31. A state shown in FIG. 9 in the plan view and in FIG. 13 in a front view is thus achieved. Since such an angle that the line which is the extension of the central axis of through hole 32e on the side of first side end portion 32cb (the chain dotted line close to first side end portion 32cb in FIG. 11) does not intersect with the front end portion of side plate portion 50b is set, side plate portions 50b and 50c do not interfere with screwing of fixing member 37.

Thereafter, combustion apparatus 100 in the present embodiment is manufactured by assembling other members such as a pipe in housing 50 and attaching the front lid member to housing 50.

A function and effect of the present embodiment will now be described.

According to the present embodiment, chamber 31 is attached to housing 50 by being inserted into housing 50 through the front opening of housing 50. With chamber 31 being attached to housing 50, intake port 31d of chamber 31 opens diagonally forward in first attachment surface 31ba. Therefore, emission port 32d of fan 32 can communicate with intake port 31d of chamber 31 by inserting fan 32 through the front opening of housing 50. Therefore, in assembly of combustion apparatus 100, combustion apparatus 100 can be assembled by inserting both of chamber 31 and fan 32 through the front opening of housing 50. Since the necessity for an operation for assembly on the rear side of housing 50 is thus obviated, the assembly operation is facilitated.

In maintenance as well, maintenance can be done simply by performing works from the front of housing 50. Therefore, a maintenance work is also facilitated.

Intake port 31d of chamber 31 opens diagonally forward in first attachment surface 31ba. Therefore, mixture gas from fan 32 can be fed to chamber 31 diagonally rearward from diagonal front. A long length of a path for the mixture gas can thus readily be secured also in small-sized combustion apparatus 100 and the gas is well mixed. Therefore, it is not necessary to increase a size of housing 50 for better mixing of the gas. Therefore, increase in size can be suppressed.

Combustion apparatus 100 of which assembly and maintenance are facilitated and of which increase in size can be suppressed can thus be obtained.

If a suction port of the chamber opens rearward in the housing with the chamber being attached to the housing, it is difficult to directly connect the fan case to the chamber with a screw after the chamber is arranged in the housing. Therefore, another member such as a caulking member is required, the number of components is greater, and assemblability and maintenability are deteriorated.

In the present embodiment, intake port 31d of chamber 31 opens toward the front of housing 50. Therefore, direct connection of fan 32 to chamber 31 with screw member 37 from the front of housing 50 is facilitated, another component for connection therebetween is not required, the number of components can be decreased, and assemblability and maintenability are improved.

In a combustion apparatus of a totally primary combustion type, air and fuel gas should be mixed inside a fan. Therefore, sealability and pressure resistance of a fan case are required, and consequently a weight of the fan increases. When such a fan is mounted on a combustion apparatus of an inverse combustion type, the fan tends to drop due to the weight of the fan in attachment and removal of the fan.

In contrast, in the present embodiment, as shown in FIG. 3, chamber 31 includes engagement portion 31c. Engagement portion 31c includes opposing portion 31c a which is opposed to first attachment portion 31b with a gap lying therebetween. As shown in FIG. 4, fan 32 includes insertion portion 32f As shown in FIGS. 6 and 7, insertion portion 32f is inserted in between first attachment portion 31b and opposing portion 31ca with chamber 31 and fan 32 being fixed to each other.

By thus inserting insertion portion 32f in between first attachment portion 31b and opposing portion 31ca of engagement portion 31c, insertion portion 32f can be engaged with both of first attachment portion 31b and opposing portion 31ca. Thus, as shown in FIG. 12, fan 32 can be held by chamber 31 as being caught thereby before fan 32 is fixed to chamber 31. Therefore, drop of fan 32 from chamber 31 during an operation to fix fan 32 to chamber 31 can be suppressed. Therefore, an operation to fix fan 32 to chamber 31 is facilitated.

In the present embodiment, as shown in FIG. 7, chamber 31 includes inclined surface 31bb which continues to first attachment surface 31ba in the rear of first attachment surface 31ba. With inclined surface 31bb, an area where first attachment surface 31ba and second attachment surface 32ca are opposed to each other can be decreased. Therefore, a high surface pressure between first attachment surface 31ba and second attachment surface 32ca can be secured. Therefore, sealability between first attachment surface 31ba and second attachment surface 32ca is improved.

Portion of joint 31bc between first attachment surface 31ba and inclined surface 31bb forms a projecting corner portion in the plan view. Therefore, burr is likely in portion of joint 31bc forming the corner portion. In the plan view, however, insertion portion 32f is opposed to corner portion 31bc with a gap lying therebetween. Therefore, burr does not impair sealability between first attachment surface 31ba and second attachment surface 32ca.

In the present embodiment, as shown in FIGS. 7 and 8, chamber 31 includes reinforcement portion 31f which connects engagement portion 31c and first attachment surface 31ba to each other at the root of engagement portion 31c. Reinforcement portion 31f reinforces engagement portion 31c. Therefore, even when a weight of fan 32 is applied to engagement portion 31c due to engagement of insertion portion 32f with engagement portion 31c, break or bending of engagement portion 31c can be suppressed.

In the present embodiment, as shown in FIG. 9, insertion portion 32f is provided in first side end portion 32cb closer to the position of center of gravity G of fan 32 than second side end portion 32cc. By thus providing insertion portion 32f in first side end portion 32cb close to the position of center of gravity G, fan 32 is well balanced when insertion portion 32f is engaged with engagement portion 31c. An operation to attach fan 32 to chamber 31 is thus further facilitated.

In the present embodiment, as shown in FIG. 9, intake port 31d of chamber 31 opens diagonally forward in first attachment surface 31ba. Therefore, fixing member 37 inserted into housing 50 through the front opening of housing 50 can fix chamber 31 and fan 32 to each other. An operation to fix chamber 31 and fan 32 to each other with the use of fixing member 37 can also be performed from the front of housing 50 and attachment and maintenance are facilitated. In particular, when such an angle that the line which is the extension of the central axis of through hole 32e on the side of first side end portion 32cb (the chain dotted line close to first side end portion 32cb in FIG. 11) does not intersect with the front end portion of side plate portion 50b of housing 50 in the plan view is set, workability for fixing a screw is further improved.

In the present embodiment, as shown in FIG. 3, height H1 from intake port 31d, of one screw member 37 of two screw members 37 located above intake port 31d of chamber 31 is greater than height H2 of the other screw member from intake port 31d. Even when motor 32b is attached to the upper portion of fan 32, one screw member 37 can be attached above intake port 31d while avoiding motor 32b.

Height H1 from intake port 31d of one screw member 37 of two screw members 37 located above intake port 31d of chamber 31 is greater than height H2 of the other screw member from intake port 31d. The other screw member 37 is arranged closer to intake port 31d than one screw member 37. Therefore, first attachment surface 31ba provided with intake port 31d and second attachment surface 32ca provided with emission port 32d can more reliably be sealed.

In the present embodiment, as shown in FIG. 4, cut portion 32h is provided in the central portion of the lower end of second attachment portion 32c. Thus, in attachment of fan 32 to chamber 31, a projecting portion on the upper surface of chamber 31 can be avoided owing to cut portion 32h and attachment of fan 32 to chamber 31 is facilitated. A height of second attachment portion 32c can be maintained low. Therefore, a large gap between top plate portion 50d of housing 50 and fan 32 can be secured and attachment of fan 32 to chamber 31 is facilitated also in this regard.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. A combustion apparatus comprising:
a housing including a back plate portion, a pair of side plate portions which extend forward from both side ends of the back plate portion and a front opening;
a chamber arranged inside the housing and including a first attachment surface inclined with respect to the back plate portion in a plan view and an intake port which opens forward in the first attachment surface; and
a fan including a second attachment surface provided with an emission port and attached to the chamber in a state in which the second attachment surface is opposed to the first attachment surface to communicate the emission port with the intake port of the chamber.

2. The combustion apparatus according to claim 1, wherein
the chamber includes a first attachment portion including the first attachment surface and an engagement portion having an opposing portion which is opposed to the first attachment portion with a gap lying between the first attachment portion and the opposing portion, and
the fan includes a second attachment portion including the second attachment surface and an insertion portion connected to the second attachment portion and inserted in between the first attachment portion and the opposing portion while the chamber and the fan are fixed to each other.

3. The combustion apparatus according to claim 2, wherein
the first attachment portion includes an inclined surface which continues to the first attachment surface,
a portion of joint between the first attachment surface and the inclined surface forms a projecting corner portion in the plan view, and
the insertion portion is opposed to the corner portion with a gap lying between the insertion portion and the corner portion in the plan view.

4. The combustion apparatus according to claim 2, wherein
the chamber further includes a reinforcement portion which connects the opposing portion and the first attachment portion to each other at a root of the engagement portion.

5. The combustion apparatus according to claim 2, wherein
the second attachment portion includes a first side end portion located laterally to the emission port and a second side end portion while the emission port lies between the second side end portion and the first side end portion,
the first side end portion is located closer to a position of a center of gravity of the fan than the second side end portion in the plan view, and
the insertion portion is provided in the first side end portion.

6. The combustion apparatus according to claim 1, the combustion apparatus further comprising a fixing member which fixes the chamber and the fan to each other while the first attachment surface and the second attachment surface are opposed to each other.

7. The combustion apparatus according to claim 6, wherein
the fixing member includes at least a first screw member and a second screw member,
the chamber includes a first screw hole in which the first screw member is inserted and a second screw hole in which the second screw member is inserted, and
both of the first screw hole and the second screw hole are arranged at positions higher than the intake port and the first screw hole is arranged at a position higher than the second screw hole with respect to the intake port.

8. A method of manufacturing a combustion apparatus comprising:
preparing a housing including a back plate portion, a pair of side plate portions which extend forward from both side ends of the back plate portion and a front opening;
inserting a chamber including a first attachment surface provided with an intake port through the front opening into inside of the housing and attaching the chamber to the housing such that the first attachment surface is inclined with respect to the back plate portion in a plan view and the intake port opens forward in the first attachment surface; and
inserting a fan including a second attachment surface provided with an emission port through the front opening into the inside of the housing and fixing the fan to the chamber in a state in which the second attachment surface is opposed to the first attachment surface to communicate the emission port with the intake port of the chamber.

9. The method of manufacturing a combustion apparatus according to claim 8, wherein
the chamber is prepared to include a first attachment portion including the first attachment surface and an engagement portion having an opposing portion which is opposed to the first attachment portion with a gap lying between the first attachment portion and the opposing portion,
the fan is prepared to include a second attachment portion including the second attachment surface and an insertion portion provided in the second attachment portion, and
the insertion portion of the fan is inserted in between the first attachment portion and the opposing portion of the chamber after the fan is inserted into the inside of the housing through the front opening and before the fan is fixed to the chamber.

10. The method of manufacturing a combustion apparatus according to claim 9, wherein
after the insertion portion is inserted in between the first attachment portion and the opposing portion, a fixing member inserted into the inside of the housing through the front opening fixes the chamber and the fan to each other.
